(19) United States
(12) Patent Application Publication
(10) Pub. No.: US 2024/0159461 A1
(43) Pub. Date: May 16, 2024

(54) A DRYING PROCESS FOR GRANULAR POLYMER MATERIAL AND A DRYING PLANT OPERATING ACCORDING TO THIS PROCESS

(71) Applicant: Pegaso Industries S.P.A., Borgoricoo (PD) (IT)

(72) Inventor: Rinaldo PIVA, Borgoricco (PD) (IT)

(73) Assignee: Pegaso Industries S.P.A., Borgoricoo (PD) (IT)

(21) Appl. No.: 18/282,701

(22) PCT Filed: Mar. 18, 2022
(86) PCT No.: PCT/IB2022/052490

§ 371 Date: Sep. 18, 2023

(30) Foreign Application Priority Data
Mar. 19, 2021 (IT) 102021000006737

(51) Int. Cl. F26B 3/04; B01J 23/42; F26B 21/02; F26B 21/10

(52) U.S. Cl. CPC F26B 3/04; B01J 23/42; F26B 21/02; F26B 21/10; F26B 2200/08

(57) ABSTRACT

A drying plant (1) for granular polymer material based on polyethylene terephthalate (PET) comprises a hopper (2), which the granular polymer material is dried and a supply and recirculation circuit (10) for a process gas which is provided to dry the granular polymer material and comprising a catalysing group (25) which is configured to promote a decomposition reaction of contaminating substances which are present in the process gas and which are released from the granular polymer material in the hopper.

### TECHNICAL FIELD

The present invention relates to a drying process for granular polymer material, in particular based on polyethylene terephthalate (PET), and a drying plant operating according to this process.

### TECHNOLOGICAL BACKGROUND

The present invention is particularly used in industrial processes for converting plastics materials into granules by means of extrusion or moulding.

It is known that such operations require, in order to ensure an adequate level of quality of the moulded product, that the converted plastics material be free from humidity to the greatest possible extent.

However, this requirement is difficult to reconcile with the high hygroscopic properties of some plastics materials which are commonly used, such as, for example, materials based on polyethylene terephthalate (PET) or polyamide (PA) or polycarbonate (PC) or some copolymers, such as ABS (acrylonitrile butadiene styrene).

Therefore, these plastics materials, before being subjected to the extrusion or moulding process, have to be advantageously processed in suitable drying plants, where the water content of the granules is reduced to the minimum quantities required by the conversion process.

In a commonly used process, the drying of the granular polymer material is carried out inside a hopper, in which the material to be dried is placed and in which a continuous flow of a hot and dry process gas, which provides for desorbing (“stripping”) the water present in the granules by coming into contact with the granular material, is introduced.

The process gas, which is typically air, before being introduced into the hopper in order to come into contact with the granular material to be dried, is typically dehumidified in a suitable dehumidification unit and subsequently heated to the desired temperature.

In a common embodiment, the process gas which provides for the polymer material to be dried is always the same (except for any reintegration fractions) so that the drying plant comprises a supply and recirculation circuit which recovers the process gas being discharged from the hopper and, after it has been dehumidified and heated, provides for it to be re-introduced into the hopper.

In other words, the process gas is recirculated in the hopper after it has been suitably processed.

The Applicant has observed that, during the drying process for a number of polymer materials, and in particular PET, some undesirable contaminating substances can become formed or released, the presence of which inside the final product can prejudice its correct use or even make it unsuitable for particular applications.

This disadvantage may become particularly stringent if final products which are intended for contact with foodstuffs, such as PET, where the potential substances released by the plastics material to the food product must not in any manner modify the organoleptic characteristics of the food product (particularly the taste or the smell thereof) and even compromise the safety thereof in terms of toxicity.

Therefore, there is provision for the concentration of the contaminating substances to be maintained below predefined thresholds which, in some cases, are specifically determined by the regulations.

A first significant example of an undesirable contaminating substance is constituted by benzene (or the derivatives thereof), the presence of which inside a plastics material intended for contact with food products, for example, for containing drinks, is standardized in a particularly stringent manner.

A second example of an undesirable contaminating substance is constituted by acetaldehyde which is formed as a by-product of the esterification reaction of polyethylene terephthalate (PET), a plastics material which is commonly used in the production of drinks bottles.

The acetaldehyde has an odour and a flavour which are very pungent, as a result of which the release thereof could alter the taste of the drink contained in the bottle.

The Applicant has further observed that the presence of these contaminating substances is particularly significant when the polymer material based on PET to be dried comprises a relevant fraction of recycled material.

On the other hand, the Applicant has found that the use of polymer material based on recycled PET is increasingly required by the market even in light of the evident decreases, which are positive from the environmental point of view. What has been set out above therefore indicates the requirement for developing solutions which allow a substantial reduction in the content of contaminating substances within the polymer material based on PET during the treating process thereof.

### DESCRIPTION OF THE INVENTION

The problem addressed by the present invention is to provide a drying process for granular polymer material based on PET and a corresponding drying plant which are structurally and functionally configured to at least partially overcome one or more of the disadvantages set out above with reference to the cited prior art.

In particular, an object of the present invention is to provide a drying process and plant for granular polymer material based on PET which reduces the concentration of contaminating substances of polymer material which is intended for the production of containers for food products, in particular drinks bottles.

Another object of the invention is to provide a drying plant which is simple to construct and implement.

The problem and the objects indicated above are solved and achieved by the present invention by a drying process and plant comprising one or more of the features expressed in the appended claims.

In a first aspect thereof, the present invention is directed towards a drying plant for granular polymer material based on polyethylene terephthalate (PET), comprising a hopper, in which the granular polymer material is dried and a supply and recirculation circuit which is configured to supply a process gas to the hopper in order to dry the granular polymer material and to at least partially recover the process gas at the discharge of the hopper in order to supply it to the hopper again.

The supply and recirculation circuit preferably comprises a heating unit which is configured to heat the process gas.

The supply and recirculation circuit comprises a catalysing group which is configured to promote a decomposition reaction of contaminating substances which are present in the process gas and which are released from the granular polymer material in the hopper.

Preferably, the catalysing group is positioned inside the heating unit.

In a second aspect thereof, the present invention is directed towards a drying process for granular polymer material based on polyethylene terephthalate (PET), comprising the steps of:
providing the granular polymer material inside a drying hopper,
introducing into the drying hopper a process gas in order to dry the granular polymer material,
at least partially recovering the process gas at the discharge of the drying hopper,
placing the process gas recovered from the drying hopper in contact with a catalysing group capable of promoting a decomposition reaction of contaminating substances comprising benzene and/or acetaldehyde present in the process gas so as to obtain a purified process gas and
re-introducing the purified process gas in the drying hopper.

As a result of the features set out above, the drying plant and process of the present invention allow a substantial reduction in the presence of contaminating substances inside the polymer material based on PET being discharged from the hopper, by acting on the process gas used for drying it.

In other words, the Applicant has perceived that the process gas can be used not only as a means for heating the polymer material and for stripping the water present in the granule but also for stripping any contaminating substances present in the plastics material and that these contaminating substances can be advantageously eliminated before the gas is again re-introduced into the hopper.

This advantageous result has been achieved by the Applicant which has positively experimented as to how it is possible to eliminate (or substantially reduce) the contaminating substances from the process gas by bringing it into contact with a catalyst capable of promoting a decomposition reaction of those substances.

In particular, the Applicant has observed that the contaminating substances of greatest interest are hydrocarbons which, under particular temperature conditions and in the presence of a suitable catalyst, can be decomposed by means of an oxidation reaction (complete or virtually complete) which converts them into non-hazardous elemental substances, typically water and carbon monoxide.

Furthermore, the Applicant has advantageously found that the decomposition reactions promoted by the catalyst can also be carried out under the temperature conditions already present inside the circuit of the process gas, therefore without any need for modifying the processing steps for the process gas.

In fact, in a particularly preferred manner, the catalysing group is positioned inside the heating unit, where the temperatures reached by the process gas are higher.

In this manner, there is obtained a greater level of efficiency of the catalyst and, consequently, a higher percentage of decomposition of the contaminating substances.

The drying plant for granular polymer material constructed according to the present invention is particularly suitable for drying granular polymer material containing recycled PET. In fact, the catalysing group of the process gas is particularly effective for reducing contaminating substances in the form of hydrocarbons, particularly acetaldehyde, benzene and relevant derivatives.

The present invention, in at least one of the above-described aspects, may have at least one of the preferred features described below.

In a preferred embodiment, the granular polymer material comprises a fraction of recycled PET. The fraction of recycled PET may be between 1% and 100%, for example, it may be greater than 10%, more preferably greater than 20%, even more preferably equal to or greater than 50%.

Preferably, the granular polymer material is used for producing containers for food products, more preferably for producing drinks bottles.

In an alternative embodiment, the catalysing group is positioned immediately downstream of the heating unit.

Preferably, the temperatures at which the process gas comes into contact with the catalyst are greater than 160°, preferably greater than 180°, for example, between approximately 200° C. and 210° C.

In an embodiment, the heating unit comprises one or more heating elements of the process gas and it preferably comprises a plurality of heating elements which are positioned in series inside the heating unit.

Preferably, the catalysing group is positioned inside the heating unit between all the heating elements of the heating unit and a discharge of the heating unit. In this manner, the catalysing group can advantageously also be used as a standardizing member for the flow of process gas. In fact, the passage of the process gas through the catalysing group brings about a pressure reduction which eliminates any preferential currents inside the gas flow.

It may be noted that, as a result of this feature, it is possible to eliminate the presence of a suitable deflector filter which is commonly mounted in the vicinity of the discharge of the individual heating unit in order to standardize the flow of process gas.

Furthermore, this feature allows the catalysing group to be mounted in place of the deflector filter so that the overall dimensions of the heating unit and the internal arrangement thereof remain substantially unchanged.

Not only this, this feature advantageously allows the solution of the present invention also to be able to be readily implemented in drying plants which already exist and are already operational, simply by replacing the deflector filter with the catalysing group.

In an alternative embodiment, the catalysing group is positioned inside the heating unit in a position between two heating elements, preferably between the last heating element and the penultimate heating element.

It is further possible to provide for the catalysing group to be able to be subdivided into a plurality of pieces, of which one or more pieces can be positioned between the heating elements and one or more pieces can be positioned downstream of all the heating elements and upstream of the discharge from the heating unit.

In one embodiment, the catalysing group comprises a support frame which is at least partially covered by a catalysing element.

Preferably, the support frame is fixed to the heating unit and, even more preferably, it occupies the entire passage cross-section of the process gas inside the heating unit so as to minimize the losses of load.

This further allows flow speeds of the gas which are not excessively high, which allows contact times between the process gas and the catalyst which are sufficiently long to give rise to the decomposition reaction.

In one embodiment, the support frame comprises a grid which is defined by a plurality of mesh (also called “cells”), through which the process gas flows.

The catalysing element is preferably deposited on the mesh.

Preferably, the grid is formed in the manner of a honeycomb and even more preferably the grid has a density of mesh per unit of surface area between 300 and 800 mesh per square inch, more preferably between 400 and 600 mesh per square inch.

The performance levels of the catalysing group are thereby optimized in terms of contact times with the process gas and loss of load.

In a particularly preferred embodiment, the catalysing element is based on platinum.

Preferably, all the process gas is placed in contact with the catalysing group before being re-introduced into the hopper.

In this manner, the action of purging the process gas of the contaminating substances is carried out extensively over the entire quantity of gas introduced into the hopper.

### BRIEF DESCRIPTION OF THE DRAWINGS

The features and advantages of the invention will be better understood from the detailed description of a preferred embodiment thereof which is illustrated by way of non-limiting example with reference to the appended drawings, in which:

FIG. 1 is a schematic view of a drying plant for granular polymer material constructed according to the present invention,

FIG. 2 is a schematic front view, drawn to an enlarged scale, of a component of the plant of FIG. 1, without any external covering,

FIG. 3 is a schematic, perspective view, drawn to an enlarged scale, of another component of the plant of FIG. 1.

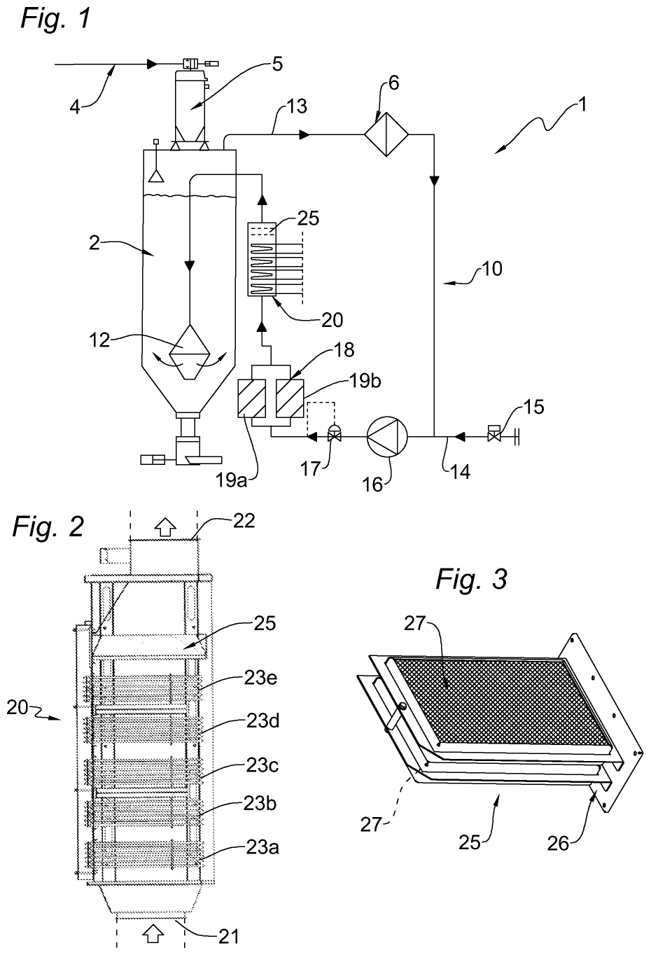

### PREFERRED EMBODIMENT OF THE INVENTION

In the Figures, there is generally designated 1 a drying plant for granular polymer material based on polyethylene terephthalate (PET) constructed according to the present invention.

The processed polymer material is formed by granules of polyethylene terephthalate (PET), of which a relevant fraction, for example, approximately 50%, is from recycled PET.

The plant 1 can be provided to supply a conversion machine of the granular polymer material (not shown), such as, for example, a press or an extruder.

In the embodiment described herein, there is provided a single drying hopper but there may also be provided two or more hoppers which are arranged in series or in parallel.

The plant 1 comprises a charging line 4 which is provided to charge the granular polymer material to be dried in the hopper 2, by means of a supply hopper 5.

The plant 1 further comprises a supply and recirculation circuit 10 which is associated with the hopper 2 in order to introduce therein a hot and dry process gas which, by passing through the granular material contained in the hopper 2, is able to reduce the level of humidity thereof to the desired and appropriate levels for the subsequent processing steps.

The process gas is typically air, but it may also be an inert gas without any oxygen.

In particular, the supply and recirculation circuit 10 introduces the process gas into the hopper 2 through an inlet pipe 11, at the internal end of which a diffusor 12 is mounted on the hopper 2.

After passing through the granular polymer material contained in the hopper 2, the process gas is recovered at the discharge from the top of the hopper 2 from a discharge pipe 13 of the supply and recirculation circuit 10.

There is mounted on the discharge pipe 13 a filtration device 6, for example, a separation cyclone, which is configured to separate the process gas from any powder which is conveyed from the interior of the hopper 2. The discharge pipe 13 is therefore connected to the inlet pipe 11 in order to place the process gas discharged from the hopper 2 back into circulation. A reintegration line 14 controlled by a valve 15 is further provided to reintegrate, if necessary, the process gas present in the supply and recirculation circuit 10 with fresh process gas.

The supply and recirculation circuit 10 further comprises a movement unit 16, comprising one or more blowers which can move the process gas along the supply and recirculation circuit 10.

Downstream of the movement unit 16, there is provided a flow regulation device 17 which is configured to regulate the process gas flow to be introduced into the hopper 2.

The supply and recirculation circuit 10 further comprises a dehumidification unit 18 which is positioned downstream of the flow regulation device 17 and which is configured to dehumidify the process gas up to predefined values of absolute humidity (for example, which correspond to a dew point of the process gas between −30° C. and −50° C.) which are suitable for drying the granular polymer material inside the hopper 2.

The dehumidification unit 18 may be of any known type in the sector and may, for example, comprise a pair of towers 19a and 19b which are identical to each other and each of which contains a suitable quantity of drying compound, for example, molecular sieves which are connected to each other in parallel so as to be selectively and alternately connected to the supply and recirculation circuit 10.

The degree of dehumidification of the process gas can be measured downstream of the dehumidification unit 18 and can preferably be adjusted by acting on the operating conditions of the towers 19a, 19b.

The supply and recirculation circuit 10 further comprises a heating unit 20 which is positioned downstream of the dehumidification unit 18 and which is provided to heat the process gas to the predefined temperature for introduction into the hopper 2, for example, approximately 180° C.

As can better be seen in FIG. 2, the process gas flows inside the heating unit 20 between an inlet 21 and a discharge 22 which are longitudinally opposite each other and between which there are arranged in series a plurality of heating elements 23a-23e which are formed, for example, by electrical resistance groups.

A catalysing group 25, which is configured to promote a decomposition reaction of contaminating substances present in the process gas, is positioned between the last heating element 23e and the discharge 22.

In particular, the catalysing group 25 is configured to promote an oxidation reaction of the hydrocarbons present in the process gas and, in a preferred manner, to promote the oxidation reaction of benzene and acetaldehyde.

To this end, the catalysing group 25 comprises a support frame 26 which is fixed to the covering of the heating unit 20 and which extends over the entire passage surface of the process gas.

The support frame 26 comprises at least one grid 27 which is positioned transversely relative to the passage direction of the process gas.

In the preferred embodiment described herein, as can better be seen in FIG. 3, there are provided two grids 27 which are mutually parallel and arranged one following the other.

Each grid 27 has mesh which are in the form of a honeycomb with a density of approximately 600 mesh per square inch and the mesh are covered with platinum which acts as a catalysing element for the oxidation reaction of the hydrocarbons.

The plant 1 operates in the manners described below.

The granular polymer material is charged by means of the charging line 4 into the hopper 2, where it is dried by means of contact with the process gas which is introduced into the hopper 2 through the supply and recirculation circuit 10. The process gas is moved along the supply and recirculation circuit 10 by the action of the movement unit 16 while the flow thereof is regulated by the flow regulation device 17 in accordance with control methods which are known per se in the field.

Then, the process gas is dehumidified in the tower 19a or 19b and is then conveyed to the heating unit 20, where it is heated by the heating elements 23a-23e.

After the last heating element 23e, the process gas which at this point is at a temperature of approximately from 200° C. to 210° C. is conveyed to the catalysing group 25 where, by passing through the mesh 27, it moves into contact with the catalyst which is made from platinum and which promotes the oxidation reaction of the hydrocarbons present in the process gas, in particular benzene and acetaldehyde.

In the embodiment illustrated, the process gas being introduced into the heating unit 20 has a content of approximately 60 parts per billion (ppb) of benzene and a content of approximately 3 ppm of acetaldehyde, while at the discharge of the heating unit 20, as a result of the action of the catalysing group 25, the process gas has a content of approximately 10 ppb of benzene and approximately 1 ppm of acetaldehyde.

The process gas is then introduced into the hopper 2 through the inlet pipe 11 and the diffusor 12 and then brought back in the supply and recirculation circuit 10 by means of the outlet pipe 13 and then again to the movement unit 16.

Therefore, the drying plant 1 allows optimum drying of the granular polymer material contained in the hopper 2, at the same time achieving a relevant reduction of the content of contaminating substances in the material itself.

In an embodiment which is not illustrated, the catalysing group 25 is positioned inside the heating unit 20 between the last heating element 23e and the penultimate heating element 23d.

In this manner, the catalysing group 25 is heated from both sides by the heating elements.

The invention thereby solves the problem proposed, further allowing the production of polymer material with a high level of quality even when in the presence of high fractions of recycled material, in particular PET.

1. A drying plant (1) for granular polymer material based on polyethylene terephthalate (PET), the plant comprising:
a hopper (2), in which the granular polymer material is dried and
a supply and recirculation circuit (10) which is configured to supply a process gas to the hopper (2) in order to dry the granular polymer material and to at least partially recover the process gas at a discharge of the hopper in order to supply the process gas to the hopper again,
wherein the supply and recirculation circuit (10) comprises:
a heating unit (20) which is configured to heat the process gas, and
a catalyzing group (25) which is positioned inside the heating unit (20) and which is configured to promote a decomposition reaction of contaminating substances which are present in the process gas and which are released from the granular polymer material in the hopper (2).

2. The plant (1) according to claim 1, wherein the heating unit (20) comprises one or more heating elements (23a-23e) of the process gas and the catalyzing group (25) is positioned inside the heating unit between the one or more heating elements (23a-23e) and a discharge (22) of the heating unit (20).

3. The plant (1) according to claim 1, wherein the heating unit (20) comprises at least two heating elements for the process gas which are positioned in series, and the catalyzing group (25) is interposed between two heating elements of the process gas.

4. The plant (1) according to claim 3, wherein the catalyzing group (25) is interposed between the last heating element and a penultimate heating element (23e, 23d).

5. The plant (1) according to claim 1 wherein the catalyzing group comprises a support frame which is at least partially covered by a catalyzing element.

6. The plant (1) according to claim 5, wherein the support frame (26) comprises at least one grid (27) which is in the form of a honeycomb.

7. The plant (1) according to claim 1 wherein the catalyzing group (25) comprises at least one catalyzing element based on platinum.

8. A drying process for granular polymer material based on polyethylene terephthalate (PET), the method comprising:
providing the granular polymer material inside a hopper (2),
introducing into the hopper (2) a process gas in order to dry the granular polymer material,
at least partially recovering the process gas at the discharge of the hopper (2),
placing the process gas recovered from the hopper (2) in contact with a catalyzing group (25) capable of promoting a decomposition reaction of contaminating substances comprising benzene and/or acetaldehyde present in the process gas so as to obtain a purified process gas and
re-introducing the purified process gas in the hopper (2).

9. The process according to claim 8, wherein all the process gas is placed in contact with the catalyzing group (25) before being re-introduced into the hopper (2).

10. The process according to claim 8, wherein the process gas is placed in contact with the catalyzing group (25) at a temperature greater than 180° C.

11. The process according to claim 10, wherein further comprising heating the process gas in a heating unit (20) before re-introducing the process gas into the hopper (2), the process gas being placed in contact with the catalyzing group (25) inside the heating unit (20).

12. The process according to claim 8 wherein the granular polymer material comprises a fraction of recycled PET greater than 10%.

13. The process according to claim 8 wherein the granular polymer material is used for the production of containers for food products.
